(19) United States
(12) Patent Application Publication
(10) Pub. No.: US 2026/0113508 A1
(43) Pub. Date: Apr. 23, 2026

(54) SYSTEMS AND METHODS FOR DATA OBJECT COMPLIANCE TESTING

(71) Applicant: STATS LLC, Chicago, IL (US)

(72) Inventors: Ed SILVESTER, Buckinghamshire (GB); Darell LETTON, London (GB)

(73) Assignee: STATS LLC, Chicago, IL (US)

(21) Appl. No.: 19/364,516

(22) Filed: Oct. 21, 2025

Related U.S. Application Data
(60) Provisional application No. 63/710,861, filed on Oct. 23, 2024.

(51) Int. Cl. H04N 21/442; G06T 7/00; H04N 21/43; H04N 21/472

(52) U.S. Cl. CPC H04N 21/442; G06T 7/0002; H04N 21/43072; H04N 21/47205

(57) ABSTRACT

Systems and methods are disclosed for data object testing. One or more processors may receive a video data object. The one or more processors may receive one or more video specifications from a database. The one or more processors may generate an on-demand cloud testing instance having a subset of video analysis tools from a plurality of video analysis tools and computational resources determined based on the video data object and the one or more video specifications. The one or more processors may perform, in the cloud testing instance, a compliance test on the video data object based on the one or more video specifications. generate a compliance output based on the compliance test, the compliance output including instructions or parameters for automatic video editing of the video data object. The one or more processors may provide the compliance output to a downstream component.

### CROSS-REFERENCE TO RELATED APPLICATION(S)

This application claims priority to Provisional U.S. Patent Application No. 63/710,861, filed Oct. 23, 2024, the disclosure of which is hereby incorporated by reference in its entirety.

### TECHNICAL FIELD

The present disclosure relates generally to the technical field of video data processing. More particularly, the present disclosure relates to systems and methods for automated compliance testing of video data objects by computationally efficient selection of tools and computational resources.

### BACKGROUND

Traditional methods of video data compliance testing involve manual review and analysis, which can be time-consuming and prone to human error. These methods require significant resources and expertise to ensure that video data objects meet specified standards and quality metrics. Manual testing processes are often inconsistent and may miss subtle compliance issues, resulting in potential quality degradation and non-compliance with industry standards. Automated compliance testing systems can address these challenges by providing consistent, efficient, and accurate assessments of video data objects.

The present disclosure is directed to addressing challenges such as those mentioned above. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure addresses the technical problem(s) described above or elsewhere in the present disclosure and improves the state of data incident response techniques.

In some aspects, the techniques described herein relate to a computer-implemented method for compliance testing, the method including: receiving, by one or more processors, a video data object; receiving, by the one or more processors, one or more video specifications from a database; generating, by the one or more processors, an on-demand cloud testing instance having a subset of video analysis tools from a plurality of video analysis tools and computational resources determined based on the video data object and the one or more video specifications; performing, by the one or more processors and within the on-demand cloud testing instance, a compliance test on the video data object based on the one or more video specifications; generating, by the one or more processors, a compliance output based on the compliance test including instructions for automatic video editing of the video data object; and providing, by the one or more processors, the compliance output to a downstream component.

In some aspects, compliance test includes establishing a baseline from a previous vide data object and comparing the video data object against the baseline. In some aspects, the compliance test includes measuring one or more metrics of the video data object using the subset of video analysis tools, and comparing the one or more measured metrics with the one or more video specifications. In some aspects, the on-demand cloud testing instance is generated using one or more containerized instances, the one or more containerized instance is dynamically scaled based on a desired workload. In some aspects, providing the compliance output through a user interface comprises generating the compliance output with a red/amber/green (RAG) status for each metric of the one or measured metrics during the compliance test. In some aspects, the video data object includes one or more of video frames, audio tracks, metadata, timecodes, and specific data packets. In some aspects, the one or more video specifications are updateable. In some aspects, the on-demand cloud testing instance includes one or more testing tools, wherein each of the one or more testing tools are configured to test an aspect of the video data object. In some aspects, the compliance test includes testing for audio-visual synchronization within the video data object. In some aspects, the compliance test comprises testing for a video resolution and a bit rate compliance within the video data object.

In some aspects, the techniques described herein relate to a system including memory and one or more processors communicatively coupled to the memory, the one or more processors configured to: receive a video data object; receive one or more video specifications from a database; generate an on-demand cloud testing instance having a subset of video analysis tools from a plurality of video analysis tools and computational resources determined based on the video data object and the one or more video specifications; perform, within the on-demand cloud testing instance, a compliance test on the video data object based on the one or more video specifications; generate a compliance output based on the compliance test, the compliance output including instructions for automatic video editing of the video data object; and provide the compliance output through a user interface.

In some aspects, the compliance test includes establishing a baseline from a previous video data object and comparing the video data object against the baseline. In some aspects, The compliance test includes measuring one or more metrics of the video data object using the video analysis tools, and comparing the one or more measured metrics with the one or more video specifications to determine compliance. In some aspects, the one or more processors are configured to generate the on-demand cloud testing instance using one or more containerized instances, wherein the one or more containerized instance is dynamically scaled based on a desired workload. In some aspects, the one or more processors are further configured to generate the compliance output with a red/amber/green (RAG) status for each metric measured during the compliance test. In some aspects, the video data object includes one or more of video frames, audio tracks, metadata, timecodes, and specific data packets. In some aspects, the on-demand cloud testing instance to include one or more testing tools, wherein each of the one or more testing tools are configured to test an aspect of the video data object. In some aspects, the compliance test includes testing for audio-visual synchronization within the video data object. In some aspects, the compliance test comprises testing for a video resolution and a bit rate compliance within the video data object.

In some aspects, the techniques described herein relate to one or more non-transitory computer-readable storage media including instructions that, when executed by one or more processors, cause the one or more processors to: receive a video data object; receive one or more video specifications from a database; generate an on-demand cloud testing instance having a subset of video analysis tools from a plurality of video analysis tools and computational resources determined based on the video data object and the one or more video specifications; perform, within the on-demand cloud testing instance, a compliance test on the video data object based on the one or more video specifications; generate a compliance output based on the compliance test, the compliance output including instructions for automatic video editing of the video data object; and provide the compliance output to a downstream component.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system environment, according to some embodiments of the disclosure.

FIG. 2 is a flowchart showing a method for compliance testing, according to some embodiments of the disclosure.

FIG. 3 is a diagram showing an example components of a system, according to some embodiments of the disclosure.

FIG. 4 shows an example report, according to some embodiments of the disclosure.

FIG. 5 shows an example machine-learning training flow chart, according to some embodiments of the disclosure.

FIG. 6 illustrates an implementation of a computer system that executes techniques presented herein, according to some embodiments of the disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates generally to the technical field of video data processing. More particularly, the present disclosure relates to systems and methods for automated compliance testing of video data objects.

Traditional methods of video data compliance testing involve manual review and analysis, which can be time-consuming and prone to human error. These methods require significant resources and expertise to ensure that video data objects meet specified standards and quality metrics. Manual testing processes are often inconsistent and may miss subtle compliance issues, resulting in potential quality degradation and non-compliance with industry standards. Automated compliance testing systems disclosed herein address these challenges by providing consistent, efficient, and accurate assessments of video data objects. Such automated compliance testing systems improve video compliance technology based on, for example, selecting specific tools from a plurality of tools and/or selecting computational resources to reduce the computational load of a system or platform. Alternatively, or in addition, such automated compliance testing systems improve video compliance technology based on converting video data objects into a testable format having testing markers for implementation of the automated testing. Conventional manual testing processes, due to limitations of human minds and abilities, are not able to perform such testing at the granularity that the automated testing procedures disclosed herein provide. Further, conventional manual testing processes cannot convert video data objects into a testable format having testing markers for implementation of the automated testing.

The present disclosure pertains to the technical field of video data compliance testing. This disclosure encompasses techniques for automating the compliance testing process of video data objects against predefined video specifications. Specifically, providing systems and methods configured to generate on-demand cloud testing instances, perform comprehensive compliance tests, and provide detailed compliance outputs through a user interface. These systems leverage advanced video analysis tools to ensure that video data objects meet industry standards and quality metrics.

Traditional approaches to video data compliance testing rely heavily on manual review and fixed testing protocols. These methods are often inefficient and fail to adapt to the evolving requirements of video standards and specifications. Consequently, video data objects may suffer from quality issues and non-compliance, leading to poor user experiences and potential regulatory penalties.

Traditional systems also depend on predefined compliance methods and static testing environments. This rigidity hinders their ability to incorporate new testing tools or adapt to updated video specifications without substantial manual reconfiguration. In the context of rapidly advancing video technologies and increasing quality expectations, the inability to swiftly implement new testing protocols or adjust existing ones can significantly compromise the robustness of compliance testing processes.

To address concerns such as the above, the present disclosure provides systems and methods configured to automate the compliance testing of video data objects using on-demand cloud testing instances. By leveraging containerized instances and advanced video analysis tools, these systems can dynamically adapt to different video specifications and testing requirements. This enhances the accuracy and efficiency of compliance testing, ensuring that video data objects meet the highest standards of quality and regulatory compliance.

The system employs a modular and flexible architecture that facilitates integration with existing video data storage systems, compliance databases, and user interfaces. By decoupling the compliance testing logic from the underlying infrastructure, the system can readily adapt to changes in video specifications, regulatory requirements, or testing protocols without extensive manual intervention. This adaptability enables businesses to promptly respond to new compliance challenges, regulatory changes, and operational needs, thereby enhancing the overall quality assurance infrastructure.

On-demand cloud testing instances represent an advanced approach to video data compliance testing. Additionally, a technical advantage of using on-demand cloud testing instances lies in their ability to perform comprehensive and scalable compliance tests. By generating instances on-demand and utilizing a variety of testing tools, the system ensures thorough validation of video data objects, reducing the potential for quality issues and non-compliance. This approach not only enhances the overall reliability of video data compliance testing but also ensures that video data objects are consistently validated against the latest industry standards and specifications.

The technical improvements and advantages discussed above are not the sole improvements and advantages, and additional technical improvements and advantages will be discussed in the following sections. Further, based on the present disclosure, other technical improvements and advantages will be apparent to one of ordinary skill in the art.

As an illustrative example, consider a practical application wherein a video content provider submits a video data object for compliance testing. This scenario unfolds as follows: the provider uploads the video data object to a video processing platform equipped with one or more processors configured to automate compliance testing. The system, upon receiving the video data object, retrieves the relevant video specifications from a database.

Following the retrieval of video specifications, the system generates an on-demand cloud testing instance. This instance is dynamically scaled to handle the workload and includes various testing tools configured to analyze different aspects of the video data object.

For example, the on-demand cloud testing instance is dynamically generated to include a set of tools from a plurality of tools (e.g., from a tool library) that are automatically selected based on the video data object (e.g., type of video format, video properties such as quality, length or aspects, and/or based on the retrieved relevant video specifications from the database). In selecting specific tools from a plurality of tools, the on-demand cloud testing instance is generated to reduce the amount and of computational resources (e.g., memory, CPU usage, power, etc.) by selecting only a subset of tools from the plurality of tools that are available. Accordingly, the on-demand cloud testing instance is operated in a more computational resource efficient manner than if all of the plurality of tools were made available instead of the select subset.

According to implementations of the disclosed subject matter, a model may select specific tools from a plurality of tools. The model may be trained (e.g., using a feedback loop) to identify which tools are used for given historical testing parameters (e.g., type of video format, video properties such as quality, length or aspects, and/or based on the retrieved relevant video specifications from the database). Based on such training, the model may output specific tools (e.g., a subset of available tools) based on the parameters of an implementation (e.g., current) video data object and/or its relevant video specifications.

Further, for example, the on-demand cloud testing instance is dynamically generated with computational resources (e.g., type, amount, etc. of memory, CPU, power, etc.) required based on the given on-demand cloud testing instance. Accordingly, computational resources are allocated for a given on-demand cloud testing instance based on the requirements thereof, which allows preservation of computational resources by reducing use of unnecessary computational resources. Accordingly, dynamically generating the on-demand cloud testing instance improves overall system performances and reduces unnecessary computational use.

According to implementations of the disclosed subject matter, a model may select computational resources based on aggregating resource needs (e.g., types and amounts of resources) of the on-demand cloud testing instance (e.g., based on the selected tools, the user interface, the back-end interface, video properties or formats, and/or the like). Alternatively or additionally, the model may be trained (e.g., using a feedback loop) to identify required computational resources based on historical testing parameters (e.g., selected tools, user interface, backend interface, type of video format, video properties such as quality, length or aspects, and/or based on the retrieved relevant video specifications from the database). Based on such training, the model may output required computational resources (e.g., a subset of available computational resources) based on the parameters of an implementation (e.g., current) of the on-demand cloud testing instance, the video data object, and its relevant video specifications.

The system then performs a compliance test on the video data object against the retrieved video specifications based on the selected tools and/or computational resources. This compliance test involves measuring various metrics, such as video resolution, bit rate, audio synchronization, and metadata integrity, using industry-standard and custom-written video analysis tools. The system compares the measured metrics with the specified standards to determine compliance.

Upon completing the compliance test, the system generates a compliance output. This report includes a detailed analysis of the video data object, highlighting any deviations from the specified standards and providing a red/amber/green (RAG) status for each metric. The compliance output also includes a short recording of the tested video data object for review purposes.

The system provides the compliance output to the video content provider through a user interface. According to an example, the compliance output may be a set of instructions and/or parameters. According to this example, an automated video data object editing system may receive such instructions and/or parameters to automatically modify the video data object in accordance with the instructions and/or parameters to comply with the relevant video specifications. Such automated modification may include modifying video properties such as video duration, aspect ratios, compression properties, encoding properties, and/or the like. According to an example, the compliance output may be a compliance report. According to this example, the provider can review the output to understand the compliance status of their video data object and make any desired adjustments to meet the required standards.

This example underscores the efficiency and accuracy of the disclosed system in automating the compliance testing of video data objects. By leveraging on-demand cloud testing instances and advanced video analysis tools, the system ensures that video data objects are consistently validated against the latest industry standards, reducing the potential for quality issues and non-compliance.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description.

Various non-limiting embodiments of the present disclosure will now be described to provide an overall understanding of the principles of the structure, function, and use of systems and methods disclosed herein for data extraction.

Reference to any particular activity is provided in this disclosure only for convenience and not intended to limit the disclosure. A person of ordinary skill in the art would recognize that the concepts underlying the disclosed devices and methods may be utilized in any suitable activity. For example, while the present disclosure is in the context of video data object testing, one of ordinary skill would understand the applicability of the described systems and methods to similar tasks in a variety of contexts or environments. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and/or “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],”depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

Training a machine-learning model may include one or more machine-learning techniques, such as linear regression, logistical regression, random forest, gradient boosted machine (GBM), deep learning, and/or a deep neural network.

Supervised and/or unsupervised training may be employed. For example, supervised learning may include providing training data and labels corresponding to the training data, e.g., as ground truth. Unsupervised approaches may include clustering, classification or the like. K-Prototypes or K-Means may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc. After training the machine-learning model, the machine-learning model may be deployed in a computer application for use on new input data that the model has not been trained on previously.

As used herein, the term “video data object” may refer to a digital file or stream that contains video content. In some embodiments, the video data object may include one or more components such as video frames, audio tracks, metadata, timecodes, and specific data packets. The specific structure and composition of the video data object may vary depending on the format and encoding used.

As used herein, the term “video specifications” may refer to a set of predefined standards and criteria used to evaluate the quality and compliance of video data objects. In some embodiments, video specifications may include parameters such as resolution, bit rate, audio synchronization, metadata integrity, and other relevant metrics. The specific requirements and thresholds within the video specifications may vary depending on the intended use and industry standards.

As used herein, the term “testing instance” may refer to an isolated environment generated for the purpose of performing compliance tests on video data objects. In some embodiments, the testing instance may be a containerized instance that is dynamically scaled based on the workload. The testing instance may include various tools and resources to conduct comprehensive analysis and evaluation of video data objects. The tools and/or resources may be dynamically selected for a given testing instance as discussed herein.

As used herein, the term “video analysis tools” may refer to software applications and algorithms used to measure and evaluate various metrics of video data objects. In some embodiments, video analysis tools may include both industry-standard and custom-written tools configured to assess aspects such as video resolution, bit rate, audio synchronization, metadata integrity, and other compliance-related criteria. The specific functions and capabilities of the video analysis tools may vary depending on the testing requirements and standards being applied.

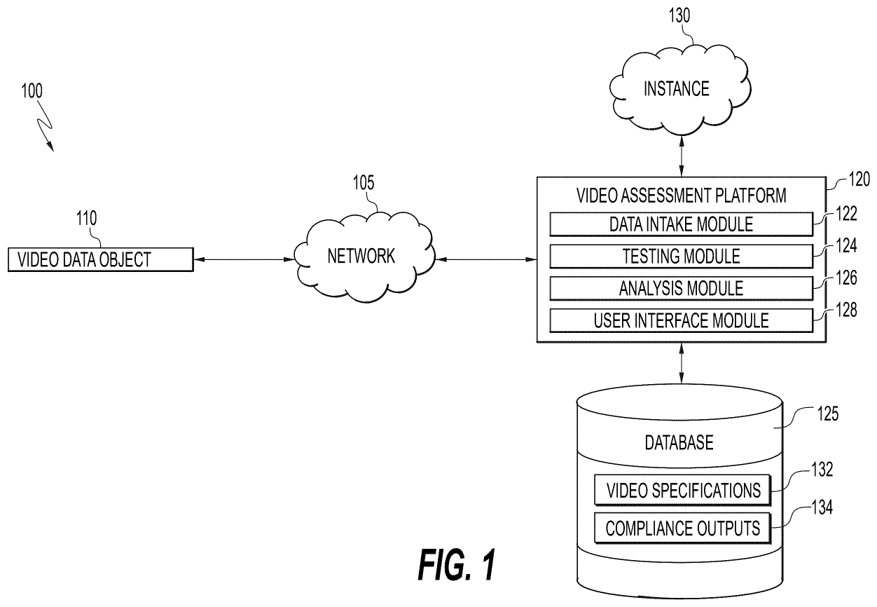

Referring to FIG. 1, an environment 100 for automated compliance testing of video data objects is depicted. The environment 100, as depicted, includes a network 105, a video data object 110, a video assessment platform 120, a database 125, and an instance 130. The video data object 110 may be received via the network 105 by the video assessment platform 120. The video assessment platform 120 is configured to process and analyze the video data object 110 to ensure compliance with one or more video specifications 132, wherein the one or more video specifications 132 are stored in the database 125. Instance 130 may be deployed or generated to utilize a subset of resources of the video assessment platform 120. The subset of resources may be selected in accordance with techniques discussed herein and based on video data object 110 and/or testing requirements.

In some embodiments, the video assessment platform 120 comprises several modules, including a data intake module 122, a testing module 124, an analysis module 126, and a user interface module 128. The data intake module 122 is configured to receive the video data object 110 through the network 105 and prepare the video data object 110 for testing. The testing module 124 is configured to perform various compliance tests on the video data object 110 based on the one or more video specifications retrieved from the database 125. The testing module 124 may operate by evaluating one or more metrics of the video data object 110, such as resolution, frame rate, or bit rate, against the corresponding video specifications 132 retrieved from the database 125. For instance, the module might compare the video data object's 110 actual frame rate with the required frame rate specified in the video specifications 132 to ensure compliance.

In some embodiments, the analysis module 126 is configured to analyze the results of the compliance tests performed by the testing module 124. The analysis may include measuring one or more metrics such as video resolution, bit rate, audio synchronization, and metadata integrity, or the like. The analysis module 126 may then generate a compliance output 134 based on the compliance test results. The user interface module 128 is configured to provide the compliance output 134 to one or more users, allowing the one or more users to review the compliance status of the video data object 110.

In some embodiments, the video assessment platform 120 and/or the database 125 may include a diverse collection of structured and/or unstructured data pertinent to video data compliance testing. The data, organized into one or more data objects, spans a variety of dimensions including video frames, audio tracks, metadata, timecodes, and specific data packets, or the like. The extensive repository may be stored in storage solutions that range from local to cloud-based data storage systems, ensuring secure storage and accessibility for ongoing processing and analytical evaluation of video data objects.

In some embodiments, the database 125 supports the storage and retrieval of data related to one or more datasets and/or data objects, such as video specifications 132, historical test results, and video analysis data. The database 125 stores metadata and operational data about entities represented in the datasets, as well as information received from the video assessment platform 120. The database 125 may comprise systems like a relational database management system (RDBMS), NoSQL database, or graph database, tailored to the specific needs and use cases within environment 100, particularly for managing the complex, interconnected data required for video data compliance testing.

In some embodiments, the database 125 may embody any type of database system where data is systematically arranged in structures such as tables, graphs, or other suitable formats. The database 125 is configured to store and facilitate retrieval of data utilized by one or more components of the environment 100, encompassing video specifications 132, video data objects 110, and platform-generated compliance outputs 134. Furthermore, the database 125 maintains a vast array of information to aid in the analysis, prediction, and management of compliance-related outcomes based on insights derived from video data analysis.

In some embodiments, the network 105 facilitates communication between the video data object 110 and the video assessment platform 120. The network 105 may be any suitable type of network, including but not limited to the Internet, a local area network (LAN), a wide area network (WAN), or a wireless network. The network 105 enables the transmission of the video data object 110 to the video assessment platform 120 for processing and analysis.

In some embodiments, the various components of the network 105 communicate by exchanging discrete packets of data. Each packet of data typically comprises (1) header information associated with a particular protocol, and (2) payload information that follows the header information and contains information that may be processed independently of that particular protocol. In some protocols, the packet of data includes (3) trailer information following the payload and indicating the end of the payload information. The header includes information such as the source of the packet of data, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically includes a physical (layer 1) header, a data-link (layer 2) header, an internetwork (layer 3) header and a transport (layer 4) header, and various application (layer 5, layer 6 and layer 7) headers, or the like.

In some embodiments, the video data object 110 includes one or more components, where the components may be video frames, audio tracks, metadata, timecodes, and specific data packets, or the like. The components are analyzed by the video assessment platform 120 to ensure compliance with the video specifications 132. The video assessment platform 120 is configured to dynamically scale its processing capabilities based on the workload, utilizing containerized instances represented by instance 130 to handle multiple video data objects simultaneously.

In some embodiments, the instance 130 represents the on-demand cloud instances generated by the video assessment platform 120 for the purpose of performing compliance tests. The generation of the instance 130 may be initiated by one or more modules within the video assessment platform 120, such as the testing module 124. The instance 130 may include various testing tools configured to test unique aspects of the video data object 110, ensuring thorough and accurate compliance evaluation. The tools and/or resources associated with or made available to instance 130 may be dynamically selected for a given testing instance as discussed herein.

For example, the on-demand cloud testing instance is dynamically generated to include a set of tools from a plurality of tools (e.g., from a tool library) that are automatically selected based on the video data object (e.g., type of video format, video properties such as quality, length or aspects, and/or based on the retrieved relevant video specifications 132 from the database). Such set of selected tools from the plurality of tools may be, for example, software applications and algorithms used to measure and evaluate various metrics of video data objects, industry-standard tools, or custom-written tools (e.g., stored in an accessible library) configured to assess aspects such as video resolution, bit rate, audio synchronization, metadata integrity, and/or other compliance-related criteria. In selecting specific tools from the plurality of tools, the on-demand cloud testing instance is generated utilizing a reduced number of computational resources (e.g., memory, CPU usage, power, etc.) as the subset of tools removes unnecessary or redundant computational resources from the testing instance.. Accordingly, the on-demand cloud testing instance is operated in a more computational resource efficient manner than if all tools were made available instead of the select subset.

According to implementations of the disclosed subject matter, a model may select one or more tools from a plurality of tools. The model may be trained (e.g., using a feedback loop) to identify which tools are used for given historical testing parameters (e.g., type of video format, video properties such as quality, length or aspects, and/or based on the retrieved relevant video specifications from video specifications 132 from the database). Based on such training, the model may output one or more tools (e.g., a subset of available tools) based on the parameters of an implementation (e.g., current) video data object and/or the relevant video specifications from video specifications 132.

Further, for example, the on-demand cloud testing instance is dynamically generated with computational resources (e.g., type, amount, etc. of memory, CPU, power, etc.) required based on the given on-demand cloud testing instance.

Accordingly, computational resources are allocated for a given on-demand cloud testing instance based on the requirements of that on-demand cloud testing instance, which allows preservation of computational resources by reducing the use of unnecessary computational resources. Accordingly, dynamically generating the on-demand cloud testing instance improves overall system performances and reduces unnecessary computational use.

According to implementations of the disclosed subject matter, a model may select computational resources based on aggregating resource needs (e.g., types and amounts of resources) of the on-demand cloud testing instance (e.g., based on the selected tools, the user interface, the back-end interface, video properties or formats, and/or the like). Alternatively or additionally, the model may be trained (e.g., using a feedback loop) to identify required computational resources based on historical testing parameters (e.g., selected tools, user interface, back-end interface, type of video format, video properties such as quality, length or aspects, and/or based on the retrieved relevant video specifications from video specifications 132 from the database). Based on such training, the model may output required computational resources (e.g., a subset of available computational resources) based on the parameters of an implementation (e.g., current) on-demand cloud testing instance, video data object, its relevant video specifications (from video specifications 132).

In operation, the environment 100 serves as a platform for processing and analyzing video data objects, utilizing techniques such as data analytics, machine learning, and database management. For instance, in an embodiment, the environment 100 facilitates the generation of insights, metrics, and compliance outputs 134 from various datasets, including video data objects and video specifications 132, according to predefined criteria or multiple parameters. Such operations may be performed via the instance 130 of environment 100 and/or one or more other components of environment 100.

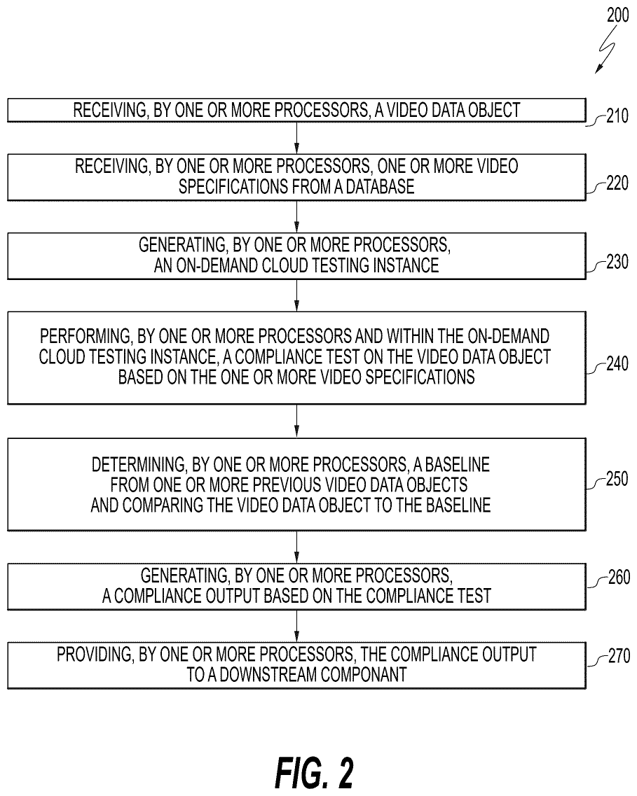

FIG. 2 is a flowchart showing a computer-implemented method 200 for video data object assessment. In some embodiments, the method 200 includes step 210, receiving, by one or more processors, a video data object. The video data object 110 may be received from suppliers through network 105. Each video data object may include various components such as video frames, audio tracks, metadata, timecodes, and specific data packets, or the like. The received video data object is prepared for analysis and compliance testing by the video assessment platform 120. This step ensures that the video data object is properly formatted and ready for subsequent processing and evaluation.

In some embodiments, the processors configured for executing the steps in the method 200 may be the same or different processors, depending on the system architecture and processing requirements. For instance, the processor that handles the receipt and initial preparation of the video data object in step 210 might be different from the processor that performs one or more subsequent steps. This enables distributed processing, where specific tasks are assigned to processors optimized for those functions, thereby enhancing efficiency and scalability within the video assessment platform 120. Alternatively, all steps may be handled by a single processor configured to execute each task in parallel and/or sequentially.

In some embodiments, the method 200 includes step 220, receiving, by the one or more processors, one or more video specifications 132 from a database. The video specifications 132 may be retrieved from database 125, which stores both current and historical video specifications. These video specifications 132 may include detailed criteria such as resolution, bit rate, audio synchronization, metadata integrity, and other relevant metrics, or the like. The video specifications 132 define the standards and thresholds that the video data object must meet to be considered compliant. According to embodiments, the video specifications 132 received from the database may be identified based on mapping properties of the video data object to corresponding applicable specification. Accordingly, an automated selection and identification of such corresponding applicable specifications may be made based on video data object properties such as format (e.g., based on format detection using a video data object format detection tool), quality, type, length, downstream purpose, and/or the like.

In some embodiments, the video assessment platform 120 interacts with database 125 to obtain the desired video specifications 132. This interaction ensures that the most up-to-date specifications are used for the compliance test. The video specifications 132 may be updateable by one or more systems or one or more users of the system, such as a video engineering team, to reflect changes in industry standards or specific project requirements. Additionally, one or more previous versions of the specifications 132 are retained in the database 125 for reference and comparison against historic video data object tests.

In some embodiments, the retrieved video specifications may encompass multiple sets of criteria to account for different products and use cases. For example, a video data object may need to conform to both primary specifications applicable to one or more, or all, projects and sub-specifications tailored to individual products. This step ensures that the video data object is assessed against one or more, or all, relevant criteria, enabling a comprehensive evaluation of its compliance with various requirements In some embodiments, the method 200 includes step 230, generating, by the one or more processors, an on-demand cloud testing instance. This step involves creating an instance 130 within the video assessment platform 120. In some embodiments, the instance 130 is generated dynamically to handle the compliance testing of the received video data object 110, as discussed herein. The instance 130 may be a containerized environment that can be scaled based on the workload. The dynamic scaling ensures that the instance 130 can efficiently handle multiple video data objects simultaneously without overloading the system. Further, the dynamic scaling ensures that specific tools and/or computational resources required for testing the video data object are utilized, while other resources remain available for use to reduce overall computational resource load. This on-demand generation of instances allows for resource optimization, as instances are spun up only for the duration of the compliance test, ensuring efficient use of computational resources.

For example, the on-demand cloud testing instance is dynamically generated to include a set of tools from a plurality of tools (e.g., from a tool library) that are automatically selected based on the video data object (e.g., type of video format, video properties such as quality, length or aspects, and/or based on the retrieved relevant video specifications from video specifications 132 from the database). Such set of selected tools of the plurality of tools may be, for example, software applications and algorithms used to measure and evaluate various metrics of video data objects, industry-standard tools, or custom-written tools (e.g., stored in an accessible library) configured to assess aspects such as video resolution, bit rate, audio synchronization, metadata integrity, and/or other compliance-related criteria. In selecting specific tools from the plurality of tools, the on-demand cloud testing instance is generated utilizing a reduced number of computational resources (e.g., memory, CPU usage, power, etc.) as the subset of tools removes unnecessary or redundant computational resources from the testing instance.. Accordingly, the on-demand cloud testing instance is operated in a more computational resource efficient manner than if all tools were made available instead of the select subset.

According to implementations of the disclosed subject matter, a model may select one or more tools from a plurality of tools. The model may be trained (e.g., using a feedback loop) to identify which of the plurality of tools are used for given historical testing parameters (e.g., type of video format, video properties such as quality, length or aspects, and/or based on the retrieved relevant video specifications from video specifications 132 from the database). Based on such training, the model may output one or more tools (e.g., a subset of available tools) based on the parameters of an implementation (e.g., current) video data object and/or the relevant video specifications from video specifications 132.

Further, for example, the on-demand cloud testing instance is dynamically generated with computational resources (e.g., type, amount, etc. of memory, CPU, power, etc.) required based on the given on-demand cloud testing instance. Accordingly, computational resources are allocated for a given on-demand cloud testing instance based on the requirements of that on-demand cloud testing instance, which allows preservation of computational resources by reducing the use of unnecessary computational resources. Accordingly, dynamically generating the on-demand cloud testing instance improves overall system performance and reduces unnecessary computational use.

According to implementations of the disclosed subject matter, a model may select computational resources based on aggregating resource needs (e.g., types and amounts of resources) of the on-demand cloud testing instance (e.g., based on the selected tools, the user interface, the back-end interface, video properties or formats, and/or the like). Alternatively or additionally, the model may be trained (e.g., using a feedback loop) to identify required computational resources based on historical testing parameters (e.g., selected tools, user interface, backend interface, type of video format, video properties such as quality, length or aspects, and/or based on the retrieved relevant video specifications from video specifications 132 from the database). Based on such training, the model may output required computational resources (e.g., a subset of available computational resources) based on the parameters of an implementation (e.g., current) of the on-demand cloud testing instance, the video data object, and/or the relevant video specifications from video specifications 132.

In some embodiments, the instance 130 may include one or more video analysis tools integrated into the environment 100, the one or more video analysis tools may be selected based on the provided video data object (and/or one or more aspects and/or characteristics thereof), one or more of the video specifications 132, and/or one or more desired application of the provided video. These tools may be industry-standard or custom tools and are configured to measure specific metrics of the video data object 110. The one or more video analysis tools are configured to test unique aspects such as audio-visual synchronization, video resolution, bit rate compliance, metadata integrity, and other relevant criteria, or the like.

The on-demand nature of the instance 130 allows the instance 130 to be generated at the time of a request, used for the compliance test, and then terminated upon completion. This approach not only optimizes resource usage but also ensures that the testing environment is always fresh and uncontaminated by previous tests, thereby maintaining high standards of accuracy and reliability in the compliance testing process.

In some embodiments, the process of generating the instance 130, for example the on-demand cloud testing instance, is fully automated by one or more processors, reducing the need for manual intervention. Automation tools can be employed to create, manage, and terminate these instances based on predefined workflows. This automation ensures consistency in the testing process and enables rapid deployment of testing environments. Orchestration tools may be utilized to manage the lifecycle of these containerized instances, facilitating smooth scaling and efficient resource utilization. One or more machine-learning models may be trained, modified, and/or updated to find associations between one or more aspects of a compliance test and the generation of the instance 130, for example an on-demand cloud testing instance.

In some embodiments, the environment 100 includes mechanisms to allocate computational resources dynamically based on the complexity and requirements of the video data object being tested. For example, a machine-learning model may be trained based on historical testing data to find associations between video data objects and required computational resources. This dynamic resource allocation ensures that each instance 130 receives the appropriate amount of CPU, memory, and storage to perform the compliance test efficiently. In some embodiments, the system implements load balancing techniques to distribute the workload evenly across multiple instances 130. Scalability features ensure that the system can handle a high volume of video data objects concurrently without degradation in performance. Load balancing not only optimizes the use of available resources but also enhances the reliability and responsiveness of the compliance testing process.

In some embodiments, the environment 100 includes a feedback loop to continuously improve the compliance testing process. Data gathered from the testing instance 130 may be analyzed using one or more machine learning models to identify patterns and areas for improvement. The insights derived therefrom are used to retrain and refine the one or more machine learning models, which may include reducing a target error rate of one or more machine learning models.

In some embodiments, the method 200 includes step 240, automatically performing, by the one or more processors, a compliance test on the video data object against the one or more video specifications 132. In some embodiments, step 240 may include one or more sub-processes to perform a compliance test. In some embodiments, the compliance test involves measuring various metrics of the video data object using the one or more video analysis tools within the instance 130. The metrics may include video resolution, bit rate, audio synchronization, metadata integrity, and other relevant parameters, or the like. The video analysis tools are configured to capture detailed measurements of the metrics to provide a comprehensive assessment of the video data object.

In some embodiments, the automated compliance test performed at step 240 may include converting video data objects into a testable format having testing markers for implementation of the automated testing. For example, data intake module 122 and/or testing module 124 may convert the video data object into a testable format that can be used within the instance 130 of video assessment platform 120. The converted video data object in the testable format may automatically add markers, pointers, tags, data objects, etc. (collectively referred to as “markers”) to the video data object. Such markers may, for example, identify an optimal subset portion of the video data object that meets threshold video properties (e.g., type of content, type of data, quality, combination of audio and/or video properties, etc.) for most efficiently or optimally identifying video resolution, bit rate, audio synchronization, metadata integrity, and other relevant parameters, or the like, using the testing tools discussed herein. For example, the optimal subset portion may be a representative portion of the video data object, and may allow for faster and/or more resource efficient testing of the video object file, allowing for reduced resource use and faster outputs (e.g., faster by approximately the ratio of the size of the optimal subset portion to the full video data object).

A video data object may automatically be converted into a testable format by a model or algorithm trained using historical video data objects and respective identification of the optimal subset portions of those historical video data objects.

Alternatively, or additionally, a video data object may be automatically sampled to identify which subsets meet the threshold video properties (e.g., type of content, type of data, quality, combination of audio and/or video properties, etc.) and each subset may be scored based on its proximity to the threshold. The subset that most closely meets or exceeds the threshold may be identified and output as the optimal subset portion of the video data object.

In some embodiments, the measured metrics are compared against the video specifications 132 retrieved from the database 125 to determine compliance. Each metric is analyzed to determine if the metric either fails, falls within an acceptable range, or meets the preferred value. If all metrics meet the preferred values, the video data object is deemed compliant, and a data marker is provided indicating such. If any metric is only acceptable, but none are failing, the overall status is acceptable, and a data marker is provided indicating such. If any metric fails, the entire report is marked as failing, and a data market is provided indicating such.

In some embodiments, the overall status of the video data object may be categorized as complaint, acceptable, or failing based on the outcomes of the metric analysis. For example, if all metrics meet the preferred values, the overall status of the video data object is deemed compliant. If any metric falls within the acceptable range, and none fail, the overall status is considered acceptable. However, if any metric fails, the overall status is marked as failing.

In some embodiments, the compliance test can be performed in one or more different modes: initial test/confirmation mode, compliance signoff mode, and compliance verification mode. Each mode may have specific requirements and reporting criteria. For example, in initial test/confirmation mode, suppliers may test arbitrary changes or new configurations without submitting for formal approval. In compliance signoff mode, the video data object is tested for final approval and compliance certification. In compliance verification mode on-demand testing of live-running data streams are tested confirmation of meeting specifications and baseline values.

In some embodiments, once a video data object 110 including a stream has been approved and is in production, on-demand tests of the live-running data stream can be performed. This involves comparing the live stream against both the specifications and baseline values established during initial testing. The report generated indicates if the stream meets the standards for the particular application and if the stream meets, exceeds, or falls below the quality observed during one or more prior testing, such as an initial testing. This ensures that the video data object maintains the required quality and compliance throughout the production lifecycle.

In some embodiments, the method 200 includes step 250, by the one or more processors, establishing a baseline from the one or more previous video data objects and comparing one or more current video data object based on this baseline to identify discrepancies. The baseline may represent the expected performance and quality metrics derived from previous tests, providing a reference point for evaluating the current video data object. The established baselines may include various metrics such as video resolution, bit rate, audio synchronization, metadata integrity, and other relevant parameters, or the like. The baseline may be derived from high-quality video data objects that previously met or exceeded the standard video specifications from video specifications 132. In some cases, the baseline values may be more stringent or closer to an ideal range than the requirements of the video specifications from video specifications 132. The system may establish these more stringent baselines as the requisite benchmarks for future compliance tests, thereby establishing an updated baseline. For a single video specification, the system can augment the various requirements with the established baseline. If a baseline value for a particular metric is higher or closer to the ideal range than the specification requirement, the system updates or replaces the specification requirement with the baseline value. This updated baseline may be applied either broadly across every testing instance, on a single testing instance, or be segmented to only apply to select testing instances, such as instances associated with a specific supplier or a specific industrial end-use case.

In some embodiments, method 200 includes step 260, generating, by the one or more processors, a compliance output 134 based on the compliance test. The compliance output may include a set of instructions to convert the video data object into a compatible/approved video data object that meets the relevant specifications. In some embodiments, the set of instructions may be a set of instructions, a set of parameters or a combination of a set of instructions and parameters. According to this example, an automated video data object editing system may receive such instructions to automatically modify the video data object in accordance with the instructions to comply with the relevant video specifications from video specifications 132. Such automated modification may include modifying video properties such as video resolution, bit rate, audio synchronization, metadata integrity, video duration, aspect ratios, compression properties, encoding properties, and/or the like. Alternatively, or additionally, this step involves compiling and presenting the results of the compliance test in a structured and detailed compliance report. The compliance report serves as a comprehensive record of the testing process and outcomes, providing information to both suppliers and internal teams.

In some embodiments, the compliance output 134 includes one or more results of one or more compliance test, detailing the analysis of various metrics measured during the test and/or generating instructions and/or parameters to update the metrics. The metrics may encompass video resolution, bit rate, audio synchronization, metadata integrity, and other relevant parameters, or the like. Each metric is evaluated against the video specifications 132 which may be predefined, and the report documents whether each metric meets the required standards.

In some embodiments, the compliance report may include a status metric, which may be a red/amber/green (RAG) status, for each metric measured during the compliance test. The RAG status provides a visual and intuitive representation of the compliance level for each metric. In some embodiments, red indicates the metric does not meet the specifications or is outside the allowed tolerances, marking the metric as unacceptable and/or failing. In some embodiments, amber indicates that the metric meets the “acceptable” criteria but not the “preferred” criteria, requiring review from one or more internal users and/or team. In some embodiments, green indicates that the metric meets the “preferred” criteria and/or value(s), marking the metric as compliant. It will be appreciated that one or more other colors may be utilized, and/or one or more symbols may be utilized instead of or in addition to one or more colors. According to some embodiments, the automated instructions and/or parameters may address only certain flagged metrics (e.g., red, red and amber, all statuses, or other subsets of statuses).

In some embodiments, the compliance output 134 may also include an overall analysis RAG status, which summarizes the overall compliance status of the video data object. This overall status is determined based on the individual RAG statuses of each metric. If all metrics meet the preferred values and are marked green, the overall status is compliant (e.g., no instructions and/or parameters may be generated). If any metric is marked amber, but no metric is marked red, the overall status is acceptable. If any metric is marked red, the entire report is marked as failing (e.g., instructions and/or parameters may be generated to address flagged issues). In some embodiments, the overall statuses may be presented, in association with one or more RAG indicator as well, or one or more other indicator. Additionally, the compliance output may include a short recording of the tested video data object. This recording serves as a reference for the visual and audio quality of the video data object during the compliance test. The recording provides tangible evidence of the stream's performance, allowing for a more thorough review and analysis by both the supplier and internal teams.

In some embodiments, the overall RAG status of a video data object may be determined through a configurable and adaptable evaluation process. The system may be configured to assign varying weights to individual metrics, thereby allowing certain metrics to influence the overall status to a greater or lesser extent. For example, the system may be configured to assign a higher weight to video resolution, such that a failure in this metric could cause the overall status to be deemed failing, even if other metrics are compliant. Accordingly, a metric having a higher weight may influence the overall status more than a metric having a lower weight. Conversely, the system may be configured to allow non-critical metrics, such as metadata accuracy, to have a reduced impact on the overall status, potentially enabling the video data object to achieve an acceptable or compliant status even if these metrics are marked as amber or red. Accordingly, a metric having a lower weight may influence the overall status less than a metric having a higher weight.

In some embodiments, the overall status may be determined based on a combination of pre-determined thresholds and cumulative impact assessments. The system may be configured to calculate the overall status as compliant if a pre-defined number or percentage of metrics are within an acceptable range and no metrics are failing. The system may also be configured to determine the overall status is acceptable if certain metrics are marked as failing, provided that the cumulative effect of the metrics does not exceed a pre-determined threshold. The system may further be configured to implement a temporal weighting mechanism, where the significance of specific metrics varies based on the time segment within the video in which the metric is assessed, potentially altering the overall RAG status based on the context of the metric's occurrence. For example, the system may be configured to ignore or otherwise discount dropped frames within a predetermined first number of frames for a video stream.

In some embodiments, the system may be configured to allow user-defined rule sets that customize the determination of the overall RAG status based on specific requirements or preferences. The system may allow users to define rules that prioritize certain metrics over others, thereby adjusting the overall status calculation according to the user's specifications. For example, a user may configure the system to treat audio quality metrics with higher significance, resulting in a failing overall status if these metrics do not meet preferred values, regardless of the status of other metrics. Alternatively, the system may be configured to allow a compliant overall status if specific non-critical metrics are marked as failing, provided that the primary metrics meet the compliance criteria. This customization allows the system to adapt the evaluation process to various use cases, ensuring that the overall RAG status accurately reflects the requirements for the video data object's intended application.

In some embodiments, the system may be configured to evaluate the cumulative impact of multiple amber or red metrics when determining the overall RAG status. The system may assess how combinations of metrics marked amber or red influence the overall video quality, potentially downgrading the status if related metrics collectively reduce the video data object's compliance. The system may also be configured to implement rules that account for the cumulative effect of metrics within specific categories, such as audio, video, or metadata, and adjust the overall status based on the aggregated impact of these metrics. This approach enables the system to provide a comprehensive and context-sensitive assessment of the video data object's compliance with the specified criteria.

In some embodiments, the compliance output 134 includes instructions for a downstream component(s) such as one or more video editing processors to automatically modify the video data object into a compatible/approved video data object. The downstream component(s) may include one or more processors that may access or include video editing tools to automatically modify the video data object to address the flags identified via the compliance test. The modifications may include, for example, modifying the video resolution, bit rate, audio synchronization, metadata integrity, video duration, aspect ratios, compression properties, encoding properties, and/or the like of the video data object by an amount or type to meet the relevant standards.

In some embodiments, a compliance report is generated using the user interface module 128, which compiles the compliance test results and organizes the compliance test results into a coherent document. The method 200 may then include step 270, providing, by the one or more processors, the compliance output 134 to a downstream component (e.g., one or more processors, through a user interface, etc.). In some embodiments, a report is made accessible to one or more users through the video assessment platform 120. The structured presentation of data ensures that relevant stakeholders have a clear and detailed understanding of the compliance status of the video data object. The compliance report may be accessed via a user interface, facilitating easy review and interpretation of the compliance test results. The user-interface may include one or more features enabling a user to drill-down to one or more aspects of the report and see more details, such as gaining additional details about one or more metric. For instance, users can click on individual metrics to view in-depth analysis, historical data comparisons, and specific measurement details. The presentation of the compliance report on the user interface allows users to gain additional insights into how each metric was assessed, the specific values obtained during the test, and how these values compare to both the predefined video specifications 132 and established baselines. Additionally, users may have access to visual aids such as graphs and charts that illustrate the performance of the video data object across different metrics, providing a comprehensive understanding of its compliance status.

In some embodiments, the video assessment platform 120 may incorporate low-code and no-code development environments to configure, adapt, and extend the compliance testing workflows of method 200 without requiring extensive programming. For example, in connection with step 210 (receiving a video data object), a no-code interface may allow an automated system or a user to configure (e.g., visually) input workflows, such as selecting permissible file formats, maximum file sizes, or automated ingestion rules for different suppliers, using drag-and-drop forms rather than programming interfaces. In connection with step 220 (retrieving video specifications 132), the automated system and/or a user (e.g., a compliance manager) may use a no-code dashboard to define or update thresholds for metrics such as resolution, bit rate, or audio synchronization, which are automatically stored in database 125 as structured specifications. Low-code functionality may further allow technical users to extend these specifications with custom validation scripts or connectors to external standards repositories.

In some embodiments, low-code/no-code functionality further enhances the scalability and adaptability of method 200 by enabling workflow automation across multiple steps. In connection with step 230 (generating an on-demand cloud testing instance), a no-code workflow builder may allow users to visually define when and how instances 130 should be provisioned, for example automatically scaling based on file size or priority of the incoming video data object. At step 240 (performing compliance tests), no-code tools may permit compliance managers to configure sequences of video analysis tools through a visual flowchart, such as running audio synchronization tests only if resolution checks have passed. In some embodiments, low-code scripts may be inserted into these workflows to integrate specialized diagnostic modules or third-party APIs. At step 260 (generating a compliance output) and step 270 (providing the report through a user interface), users may employ a no-code interface to configure report layouts, select RAG indicators, or define automated notifications to suppliers. Workflow templates may also be provided to represent common compliance patterns, which can be reused and customized by business users while still allowing users to extend them with low-code scripts. By integrating low-code and no-code design features into each stage of method 200, the video assessment platform 120 enables both technical and non-technical users to collaboratively define, execute, and evolve comprehensive compliance workflows.

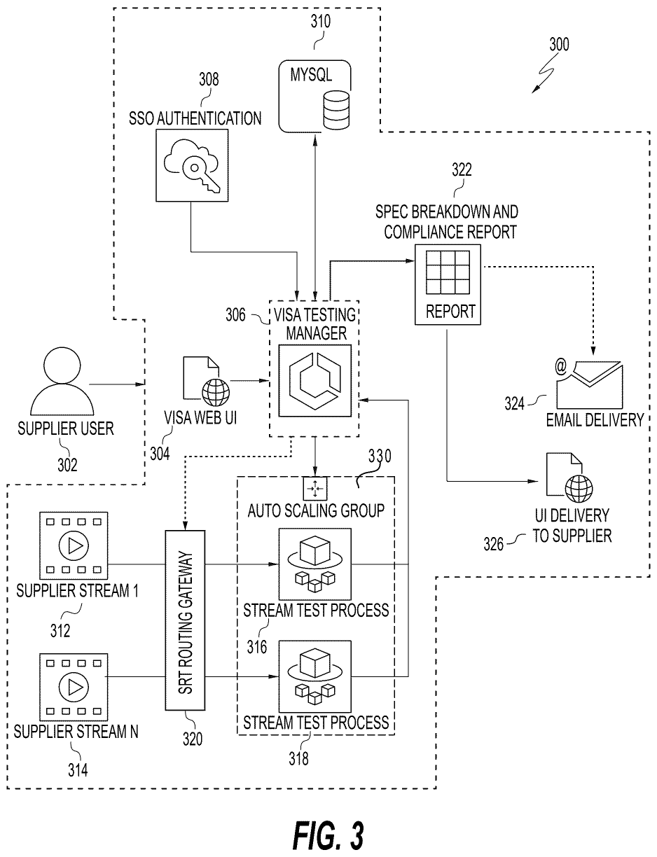

FIG. 3 illustrates a system 300 configured to intake video data objects, generate on-demand instances of testing environments, perform compliance tests, and generate a detailed compliance output. The system 300 includes several components.

In some embodiments, a supplier user 302 interacts with the system through the VISA web UI 304. The supplier user 302 may represent an individual or an organization responsible for providing video data streams for compliance testing. The VISA web UI 304 may serve as the primary interface for the supplier user 302 to submit video data objects and configure testing parameters. The VISA web UI 304 may be implemented as a web application running on a server, accessible via standard web browsers.

In some embodiments, the VISA web UI 304 is configured to interface with a VISA testing manager 306. The VISA testing manager 306 is configured to manage and coordinate the entire testing process. The VISA testing manager 306 receives input from the VISA web UI 304 and orchestrates the testing environment setup, compliance testing, and report generation. The VISA testing manager 306 may be implemented as a software application running on dedicated servers or virtual machines.

The VISA testing manager 306 is configured to interface with a MySQL database 310, which may store in one or more databases one or more video specifications (e.g., which may be the same as or similar to video specifications 132 discussed herein), supplier-provided configuration data, and/or historical test results. The MySQL database 310 may be implemented on database servers equipped with storage devices, processors, memory, and backup systems. The MySQL database 310 enables data integrity, availability, and scalability, enabling efficient retrieval and storage of large volumes of compliance-related data.

The system 300 includes a SSO authentication 308. The SSO authentication 308 is configured, in some embodiments, to enable secure access to the system. The SSO authentication 308 is configured to verify the identity of the supplier user 302 and grant access to the VISA web UI 304 based on the user's credentials. The SSO authentication 308 may be implemented using authentication protocols and services such as OAuth, SAML, or OpenID Connect. The SSO authentication 308 typically involves authentication servers, secure communication channels, and integration with existing identity management systems to provide secure access to the system.

Upon receiving a video data object and the corresponding configuration details, the VISA testing manager 306 is configured to initiate the generation of an on-demand cloud testing instance. This process is represented by an auto-scaling group 330 in FIG. 3, which is configured to dynamically create stream test processes 316 and 318 based on the workload and testing requirements. These testing instances are containerized environments that include various video analysis tools configured to measure specific metrics of the video data object. The auto-scaling group 330 may include multiple virtual machines or containers, each provisioned with dynamically determined computational resources such as CPU, memory, and storage to handle the testing tasks specific to the video data object being tested and/or its relevant testing requirements.

In some embodiments, a Secure reliable transport (SRT) routing gateway 320 component can optionally serve as an ingest point for supplier streams under test. This setup provides a true-to-life ingest point, validating the stream's configuration compliance with production ingest devices. SRT routing gateway 320 can connect in a caller mode to stream test processes 316 and 318, enhancing the testing accuracy. The SRT routing gateway 320 may include hardware such as network interfaces, processing units, and storage to handle the real-time ingest and validation of video streams, simulating the actual production environment.

In some embodiments, the stream test processes 316 and 318 are configured to perform compliance tests on the video data object, such as supplier steam 1 312 and supplier steam n 314, against the one or more video specifications retrieved from one or more database, such as the MySQL database 310. The stream test processes 316, 318 measure various metrics, including video resolution, bit rate, audio synchronization, metadata integrity, and other relevant parameters, or the like. The results of the tests are analyzed to determine if the video data object meets the predefined standards. Each stream test process 316, 318 may utilize dedicated processing resources, video analysis software, and logging mechanisms.

In some embodiments, the VISA testing manager 306 generates a compliance output 322 based on the results of the compliance tests. The compliance output 322 includes instructions, parameters, and/or a detailed analysis of the metrics, a red/amber/green (RAG) status for each metric, and an overall RAG status indicating the overall compliance of the video data object. The compliance output 322 may also include a recording of the tested stream, providing a visual and audio reference for the test results. Generating the compliance output 322 may involve data aggregation, formatting, and visualization tools to present the results comprehensively and understandably.

In some embodiments, one or more compliance output 322 is delivered to relevant stakeholders through various means. The compliance output 322 can be sent via an electronic signal to a downstream component such as a video editing processor, as an instruction or parameter file, as an email 324 to one or more team, group, user (such as an internal user), or the like for review and further action if desired. Alternatively or additionally, the output may be delivered through alternative communication channels, such as artificial intelligence agents, instant messaging platforms, SMS text messages, or push notifications, or the like. Alternatively or additionally, the compliance output 322 is made accessible to the supplier through a user interface 326, allowing a supplier system to perform the edits or the supplier review the compliance status and detailed analysis of the video data object. The delivery mechanisms may involve secure email servers, notification systems, and access control protocols to ensure the reports are delivered reliably and securely.

In operation, the system 300 facilitates the automated compliance testing of video data objects, testing that they meet the required video specifications. The dynamic generation of testing instances, comprehensive metric analysis, instructions, parameters, and detailed reporting capabilities provide a robust framework for validating video data streams. This system 300 streamlines the compliance testing process, reduces the need for manual intervention, and ensures high standards of video quality and performance.

In an exemplary scenario, the supplier user 302 provides a video data object, such as supplier stream 1 312, to the system 300 via the VISA web UI 304. After logging in securely through the SSO authentication 308, the supplier user 302 uploads the video data object and provides desired configuration details. The VISA web UI 304 then communicates this information to the VISA testing manager 306, which retrieves the relevant video specifications from the MySQL database 310 to perform the compliance test.

Continuing the example, the VISA testing manager 306 initiates the generation of on-demand cloud testing instances, managed by the auto-scaling group 330, which dynamically creates stream test processes 316 and 318. These instances, possibly utilizing SRT routing gateway 320 as an optional ingest point, include video analysis tools to measure metrics such as video resolution, bit rate, and audio synchronization for the given video data object and/or relevant video specifications. The stream test processes 316 and 318 evaluate the video data object against the video specifications, and the VISA testing manager 306 analyzes the results to determine compliance.

Continuing the example, after completing the compliance tests, the VISA testing manager 306 generates the compliance output 322, including instructions/parameters and/or detailing the analysis of measured metrics with a red/amber/green (RAG) status for each metric and an overall compliance status. The output may include a short recording of the tested stream and is delivered via email 324 to one or more team, group, user, or the like and made accessible to the supplier user 302 through the user interface 326. The supplier user 302 then may choose to use a downstream component to change one or more parameters of the video data object (e.g., based on the output instructions/parameters and using automated video editing tools), such as changing a frame rate, and re-run the test, based on the compliance output 322.

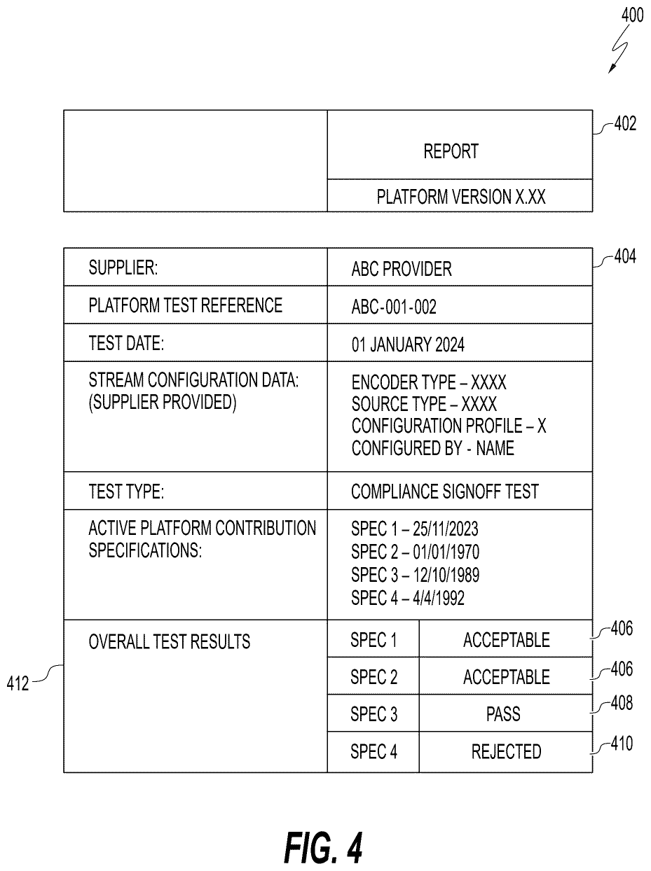

FIG. 4 illustrates an exemplary compliance output 400 report generated by the system for a video data object tested against predefined specifications, according to some embodiments. The compliance output 400 may correspond to a report. The compliance output 400 provides a structured and detailed summary of the testing results, including various sections and elements to convey the desired information to stakeholders. In some embodiments, the compliance output 400 includes a header section 402, which identifies the document as a compliance output and specifies the platform version (e.g., Platform Version X.XX). Below the header, the compliance output 400 includes a detailed section 404 providing one or more information criteria and results about the test. This section identifies the provider of the video data object, shown as “ABC Provider.” The detailed section 404 may include a unique reference number for the test, “ABC-001-002,” which helps in tracking and referencing the specific test. The compliance output 400 may also include a test date, such as “1 Jan. 2024.” The stream configuration data provided by the supplier may include detailed information about the stream configuration, such as the encoder type, source type, configuration profile, and the name of the person who configured it. For example, the data might read “Encoder Type—XXXX, Source Type—XXXX, Configuration Profile—X, Configured By-NAME.” A test type may be identified, such as a “Compliance Signoff Test.” The active platform contribution specifications against which the video data object was tested are listed along with their dates for reference, such as “SPEC 1—25/11/2023, SPEC 2—01/01/1970, SPEC 3—12/10/1989, SPEC 4—4/4/1992.” Each specification may include one or more metrics against which the video data object is tested against, each metric including its own status (such as “Pass”, “Acceptable”, and “Rejected”).

In some embodiments, the compliance output 400 also includes a section 412 summarizing the overall test results. This section details the compliance status of the video data object against each specification, using a red/amber/green (RAG) status indicator for clarity. SPEC 1 is marked as “ACCEPTABLE,” 406, and may be indicated by the color amber. SPEC 2 is also marked as “ACCEPTABLE,” 406 and may be indicated by the color amber. SPEC 3 is marked as “PASS,” 408 and may be indicated by the color green. SPEC 4 is marked as “REJECTED,” 410 and may be indicated by the color red.

In some embodiments, the RAG status provides a visual and intuitive representation of the compliance level for each specification. “ACCEPTABLE” indicates that the test results meet the “acceptable” criteria but not the “preferred” criteria, requiring review from one or more team, group, user (such as an internal user), or the like. “PASS” indicates that the test results meet the “preferred” criteria, marking the test result as compliant. “REJECTED” indicates that the test results do not meet the specifications or is outside the allowed tolerances, marking the test result as unacceptable.

In some embodiments, the compliance output 400 may include one or more sub-reports, such as a sub-report for each specification (SPEC). Each sub-report provides detailed information about the compliance of the video data object with respect to that particular SPEC. These sub-reports may include one or more metrics and measures of compliance, with each metric accompanied by its own red/amber/green (RAG) status. The metrics may encompass various aspects of the video data object, such as video resolution, bit rate, audio synchronization, and metadata integrity, or the like. By breaking down the compliance output 400 into these sub-reports, stakeholders can gain a more granular understanding of the specific areas where the video data object meets or falls short of the required specifications. This detailed reporting structure enables the ability to pinpoint issues and make informed decisions regarding the adjustments to ensure full compliance.

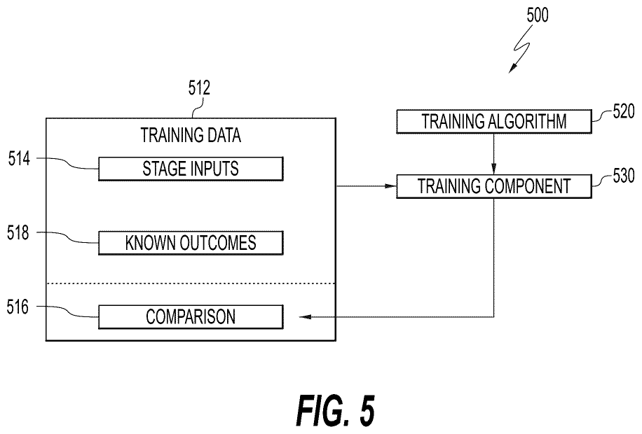

One or more implementations disclosed herein include and/or are implemented using a machine-learning model. For example, one or more of the components of environment 100 are implemented using a machine-learning model and/or are used to train the machine-learning model. FIG. 5 shows an example machine-learning training flow chart 500, according to some embodiments of the disclosure. Referring to FIG. 5, a given machine-learning model is trained using the training data 512. The training data 512 includes one or more of stage inputs 514 and known outcomes 518 related to the machine-learning model to be trained. The stage inputs 514 are from any applicable source including text, visual representations, data, values, comparisons, and stage outputs, (e.g., one or more outputs from one or more steps or components depicted in FIGS. 1-3). The known outcomes 518 are included for the machine-learning models generated based on supervised or semi-supervised training, or can based on known labels, such as topic labels. In contrast, an unsupervised machine-learning model is not trained using the known outcomes 518. The known outcomes 518 includes known or desired outputs for future inputs similar to or in the same category as the stage inputs 514 that do not have corresponding known outputs.

The training data 512 and a training algorithm 520, (e.g., one or more of the modules implemented using the machine-learning model and/or are used to train the machine-learning model), is provided to a training component 530 that applies the training data 512 to the training algorithm 520 to generate the machine-learning model. According to an implementation, the training component 530 is provided comparison results 516 that compare a previous output of the corresponding machine-learning model to apply the previous result to re-train the machine-learning model. The comparison results 516 are used by the training component 530 to update the corresponding machine-learning model. The training algorithm 520 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIG. 2 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

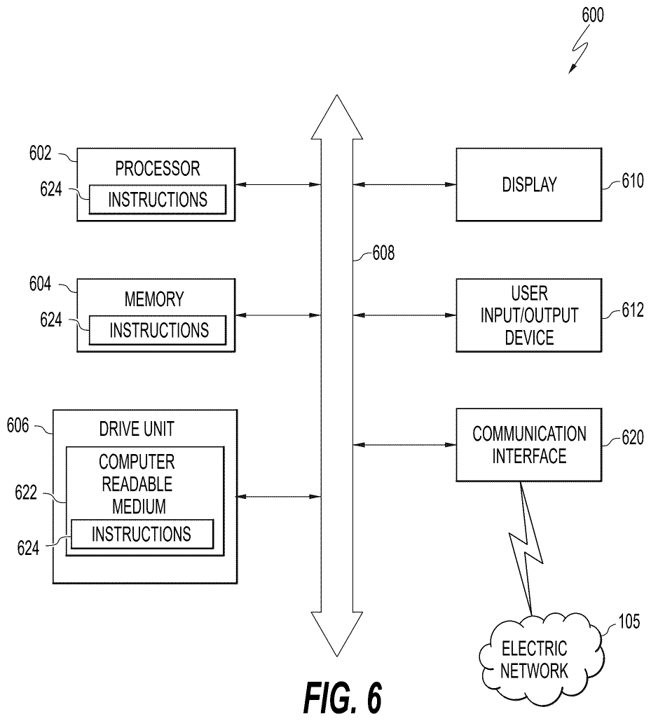

FIG. 6 illustrates an implementation of a computer system 600 that executes techniques presented herein. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,”or a “server”includes one or more processors.

In a networked deployment, the computer system 600 operates in the capacity of a server or as a client user computer in a server-client user environment, or as a peer computer system in a peer-to-peer (or distributed) environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, (e.g., a central processing unit (CPU), a graphics processing unit (GPU), or both). The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (i.e., programmed).

The computer system 600 includes a memory 604 that communicates via bus 608. The memory 604 is a main memory, a static memory, or a dynamic memory. The memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by the processor 602 executing the instructions stored in the memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. The sets of instructions 624 resides completely or partially within the memory 604 and/or within the processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to the network 105 communicates voice, video, audio, images, or any other data over the network 105. Further, the sets of instructions 624 are transmitted or received over the network 105 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 105, external media, the display 610, or any other components in the computer system 600, or combinations thereof. The connection with the network 105 is a physical connection, such as a wired Ethernet connection, or is established wirelessly as discussed below. Likewise, the additional connections with other components of the computer system 600 are physical connections or are established wirelessly. The network 105 alternatively be directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to the network 105. The network 105 defines one or more networks including wired or wireless networks. The wireless network is a cellular telephone network, a 602.10, 602.16, 602.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having one or more of the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the instructions for carrying out such a method or element of a method forms a means for carrying out the method or element of a method. Furthermore, an element described herein of an apparatus embodiment is an example of a means for carrying out the function performed by the element for the purpose of carrying out the disclosure.

In the description provided herein, numerous specific details are set forth. However, it is understood that embodiments of the disclosure are practiced without these specific details. In other instances, well-known methods, structures and techniques have not been shown in detail in order not to obscure an understanding of this description.

Thus, while there has been described what are believed to be the preferred embodiments of the disclosure, those skilled in the art will recognize that other and further modifications are made thereto without departing from the spirit of the disclosure, and it is intended to claim all such changes and modifications as falling within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method for compliance testing and editing, the method comprising:
receiving, by one or more processors, a video data object;
receiving, by the one or more processors, one or more video specifications from a database;
generating, by the one or more processors, an on-demand cloud testing instance having a subset of video analysis tools from a plurality of video analysis tools and computational resources determined based on the video data object and the one or more video specifications;
performing, by the one or more processors and within the on-demand cloud testing instance, a compliance test on the video data object based on the one or more video specifications;
generating, by the one or more processors, a compliance output based on the compliance test, the compliance output including instructions for automatic video editing of the video data object; and
providing, by the one or more processors, the compliance output to a downstream component.

2. The method of claim 1, wherein the compliance test comprises establishing a baseline from a previous video data object and comparing the video data object against the baseline.

3. The method of claim 1, wherein the compliance test comprises measuring one or more metrics of the video data object using the subset of video analysis tools, and comparing the one or more measured metrics with the one or more video specifications.

4. The method of claim 1, wherein the on-demand cloud testing instance is generated using one or more containerized instances, the one or more containerized instance is dynamically scaled based on a desired workload.

5. The method of claim 3, wherein providing the compliance output through a user interface comprises generating the compliance output with a red/amber/green (RAG) status for each of the one or more measured metrics during the compliance test.

6. The method of claim 1, wherein the video data object includes one or more of video frames, audio tracks, metadata, timecodes, and specific data packets.

7. The method of claim 1, wherein the one or more video specifications are updateable.

8. The method of claim 1, wherein the on-demand cloud testing instance includes one or more testing tools, wherein each of the one or more testing tools are configured to test an aspect of the video data object.

9. The method of claim 1, wherein the compliance test comprises testing for audio-visual synchronization within the video data object.

10. The method of claim 1, wherein the compliance test comprises testing for a video resolution and a bit rate compliance within the video data object.

11. A system comprising memory and one or more processors communicatively coupled to the memory, the one or more processors configured to:
receive a video data object;
receive one or more video specifications from a database;
generate an on-demand cloud testing instance having a subset of video analysis tools from a plurality of video analysis tools and computational resources determined based on the video data object and the one or more video specifications;
perform, within the on-demand cloud testing instance, a compliance test on the video data object based on the one or more video specifications;
generate a compliance output based on the compliance test, the compliance output including instructions for automatic video editing of the video data object; and
provide the compliance output to a downstream component.

12. The system of claim 11, wherein the compliance test comprises establishing a baseline from a previous video data object and comparing the video data object against the baseline.

13. The system of claim 11, wherein the compliance test comprises measuring one or more metrics of the video data object using the video analysis tools, and comparing the one or more measured metrics with the one or more video specifications to determine compliance.

14. The system of claim 11, wherein the one or more processors are configured to generate the on-demand cloud testing instance using one or more containerized instances, wherein the one or more containerized instance is dynamically scaled based on a desired workload.

15. The system of claim 11, wherein the one or more processors are further configured to generate the compliance output with a red/amber/green (RAG) status for each metric measured during the compliance test.

16. The system of claim 11, wherein the video data object includes one or more of video frames, audio tracks, metadata, timecodes, and specific data packets.

17. The system of claim 11, wherein the on-demand cloud testing instance to include one or more testing tools, wherein each of the one or more testing tools are configured to test an aspect of the video data object.

18. The system of claim 11, wherein the compliance test comprises testing for audio-visual synchronization within the video data object.

19. The system of claim 11, wherein the compliance test comprises testing for a video resolution and a bit rate compliance within the video data object.

20. One or more non-transitory computer-readable storage media including instructions that, when executed by one or more processors, cause the one or more processors to:
receive a video data object;
receive one or more video specifications from a database;
generate an on-demand cloud testing instance having a subset of video analysis tools from a plurality of video analysis tools and computational resources determined based on the video data object and the one or more video specifications;
perform, within the on-demand cloud testing instance, a compliance test on the video data object based on the one or more video specifications;
generate a compliance output based on the compliance test, the compliance output including instructions for automatic video editing of the video data object; and
provide the compliance output to a downstream component.
